(19) United States
(12) Patent Application Publication
(10) Pub. No.: US 2022/0256868 A1
(43) Pub. Date: Aug. 18, 2022

(54) METHOD AND APPARATUS FOR PROVIDING TOPPINGS ON OPPOSITE SIDES OF A BAKED FOOD ITEM

(71) Applicant: Papa John's International, Inc., Louisville, KY (US)

(72) Inventor: Joel Brown, Louisville, KY (US)

(73) Assignee: Papa John's International, Inc., Louisville, KY (US)

(21) Appl. No.: 17/650,454

(22) Filed: Feb. 9, 2022

Related U.S. Application Data
(60) Provisional application No. 63/150,873, filed on Feb. 18, 2021.

(51) Int. Cl. A21D 13/43; A21D 8/06; A21D 13/38; A21D 13/31; A21B 3/15

(52) U.S. Cl. CPC A21D 13/43; A21D 8/06; A21B 3/155; A21D 13/31; A21D 13/38

(57) ABSTRACT

Improved techniques of preparing baked food items (e.g., pizza, flatbread sandwich) with cheese and or toppings on both sides of the item. A baking screen may have a non-stick surface and also have a plurality of air flow holes. The combination of the non-stick surface and the air flow holes help mitigate any potential problem of the cheese and or toppings on the bottom side of the item sticking to the cooking surface.

### RELATED APPLICATION

This application claims priority to U.S. provisional Patent Application No. 63/150,873, filed on Feb. 18, 2021, which is incorporated herein by reference in its entirety.

### BACKGROUND

Baked food items such as flatbreads, flatbread-style sandwiches, pizzas, breadsticks, bread rolls, etc. remain popular in the United States. For example, pizza is a ubiquitous home delivered baked food item in the United States. Any kind of social gathering, be it a birthday party or a game night, can be facilitated by freshly baked, hot pizza delivered to the customer's home. Pizzas and similar baked food items generally have cheese and toppings only on one side of the crust/bread. There is a desire to provide toppings on both sides of the crust/bread.

However, conventional baking technology does not support providing toppings on both sides of the crust/bread on a baked food item. For instance, conventional baked food items are placed directly on an oven's floor or rack; or placed on a baking sheet and then put on the oven floor or rack with the baking sheet. If cheese and or toppings were provided on the bottom side, they would, when heated, stick to the surface they are in close contact with. For example, a pizza with toppings on its bottom side would stick to the baking sheet. This is undesirable because it may be difficult to extract the baked food item from the baking sheet or the oven floor or rack, and, even if it could be extracted, the forcible extraction may deform its shape.

Accordingly, there is a need and desire for improved techniques for baking food products with toppings on both sides, with the improved techniques overcoming the above and other shortcomings.

### SUMMARY

Embodiments disclosed herein attempt to solve the aforementioned problems and provide other solutions as well. In an embodiment, a baking screen may include a plurality of air flow holes. The baking screen may be glazed or coated to create a non-stick surface. The plurality of air flow holes allow a flow of air from the oven environment to the food item being baked on the baking screen. The combination of the non-stick surface and the flow of air mitigate any problem of the food item sticking to the surface of the baking screen. Using the disclosed baking screen, for example, a pizza with cheese and toppings on both sides can be baked. For instance, cheese and toppings may be directly spread on the baking screen. Then, a flattened dough may be spread on top of the cheese and toppings, followed by another layer of cheese and toppings on top of the flattened dough. When the pizza bakes in the oven, the layer of cheese and toppings in direct contact with the baking screen has minimal sticking to the baking screen. To customize the baking screen for different types of food items, the shape, configuration, and/or the number of air flow holes may be configured as disclosed herein. Furthermore, the thickness of the screen and the coating thereon may be configured as well.

In an embodiment, a method of making a baked food item is provided. The method may comprise spreading a first cheese and or one or more first toppings on a screen with a plurality of air flow holes; and adding a flattened dough on top of the first cheese and or one or more first toppings such that the first cheese and or one or more first toppings are in between the screen and the flattened dough. The method may also comprise, adding on the opposite side of the flattened dough facing away from the screen, a second cheese and or one or more second toppings; and baking the flattened dough with the first and second cheese and or the first and second one or more toppings using the screen. In one or more embodiments, after the baking, the method may comprise folding the baked flattened dough such that the opposite side of the flattened dough forms a pocket for the second cheese and or one or more second toppings.

In another embodiment, a method of making a flattened dough product with protein and cheese on both sides is provided. The method may comprise spreading a first cheese and a first protein on a baking screen with a plurality of air flow holes; and adding a flattened dough on top of the first cheese and the first protein such that the first cheese and the first protein are attached to the first side of the flattened dough facing the baking screen. The method may also comprise adding, on the second side of the flattened dough facing away from the baking screen, a second cheese and a second protein; and baking, using the baking screen, the flattened dough with the first and second cheese and the first and second proteins.

In yet another embodiment, a baking screen for a flattened dough product is provided. The baking screen may comprise a flat surface configured to: receive a first layer of toppings and or cheese and a second layer of flattened dough; and provide contact heating to the toppings and or cheese and the flattened dough. The baking screen may comprise a plurality of air holes through the flat surface configured to allow air flow between the toppings and or cheese, the flattened dough and the heating environment of an oven.

### BRIEF DESCRIPTION OF DRAWINGS

Other objects and advantages of the present disclosure will become apparent to those skilled in the art upon reading the following detailed description of exemplary embodiments and appended claims, in conjunction with the accompanying drawings, in which like reference numerals have been used to designate like elements, and in which:

FIG. 1 shows an illustrative environment, wherein the principles disclosed herein may be employed.

FIG. 2 shows an illustrative process of preparing a food item for baking, based on the principles disclosed herein.

FIG. 3 shows another illustrative process of preparing a food item for baking, based on the principles disclosed herein.

FIG. 4 shows an illustrative folded baked food item, based on the principles disclosed herein.

FIGS. 5A-5C show illustrative baking screens with tabs, based on the principles disclosed herein.

FIGS. 6A-6B show some examples illustrative baking screens, based on the principles disclosed herein.

FIGS. 7A-7B show other examples of illustrative baking screens, based on the principles disclosed herein.

FIG. 8 shows a flow diagram of an illustrative method of making a baked food item, based on the principles disclosed herein.

FIG. 9 shows a flow diagram of another illustrative method of making a baked food item, based on the principles disclosed herein.

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments disclosed herein may provide improved techniques of preparing baked food items (e.g., pizza, flatbread sandwich) with cheese and or toppings on both sides of the item. A baking screen may have a non-stick surface and also have a plurality of air flow holes. The combination of the non-stick surface and the air flow holes mitigate any potential problem of the cheese and or toppings on the bottom side of the item sticking to the cooking surface. The baking screen may be custom manufactured based on the characteristics of the baked food item such as the thickness of the food item, desired crispiness, etc. Some example customization parameters may include the thickness of the baking screen, coating and/or glazing applied on its surface, shape and size of the air flow holes, and/or the total number and distribution of the air flow holes.

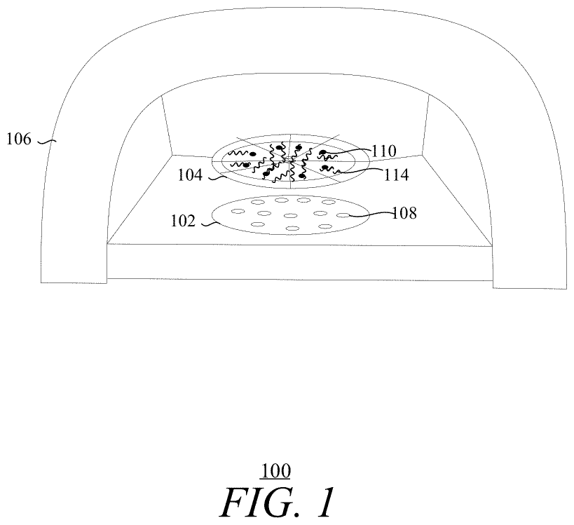

FIG. 1 shows an illustrative environment 100, wherein the principles disclosed herein may be employed. It should be understood that the illustrative environment 100 and the components thereof are merely for illustration and for an ease of explanation, and environments with alternate, additional, or fewer number of components should also be considered within the scope of this disclosure. It should further be understood that the flatbread type food item 104 (e.g., pizza) is also for illustrative purposes only and should not be considered limiting. Likewise, the disclosed principles should not be limited to the illustrated cheese and or toppings discussed in the various examples.

As shown, the illustrative environment 100 may include an oven 106 and a baking screen 102, which may receive the food item 104 to be baked in the oven 106. The oven 106 should be understood to include any kind of mechanism, such as a wood fire, coal fire, gas fire, and/or electrically heated mechanism for baking the food item 104 on the baking screen 102. The act of baking the food item 104 may include baking the dough contained therein along with heating, cooking, or partially cooking a topping 110 and or cheese 114 on the dough.

In some instances, the food item 104 may include cheese and/or toppings on both sides of the dough. In the illustrative environment 100, in addition to the cheese 114 and or toppings 110 on the side facing away from the baking screen 102, there may be toppings and or cheese on the side facing the baking screen 102. That is, the additional toppings and or cheese may be in contact with the baking screen 102. As noted above, conventional baking sheets are unsuitable for such double-sided cheese and or toppings.

To that end, the baking screen 102 may use a combination of a non-stick surface and a plurality of air flow holes (an illustrative air flow hole is labeled as 108). The non-stick surface may be generated by glazing the baking screen 102 or coating the baking screen 102 with materials such as Polytetrafluoroethylene (PTFE), Teflon, etc. It should be understood that these methods of generating a non-stick surface are mere examples, and any other method of creating such surface should be considered within the scope of this disclosure.

The air flow holes (e.g., air flow hole 108) may allow air to circulate between oven 106 environment and the bottom surface of the food item 104 (e.g., the surface in contact with the baking screen 102 during baking). This circulation of air may create an upward pressure on the food item 104 to mitigate its stickiness to the baking screen 102 and to help bake the item. The air flow holes may also cause a thin film of air to develop between the food item 104 and the baking screen 102, which also may mitigate the stickiness between the food item 104 and the baking screen 102.

In addition to the air flow and air pressure attributes, the air flow holes may reduce the surface area of contract between the bottom surface of the food item 104 and the baking screen 102. This reduced surface area of contact may inherently cause a proportional reduction to the stickiness between the baking screen 102 and the food item 104 in addition to helping the item bake properly. Furthermore, the air flow holes may break any contours of stickiness that may still develop between the food item 104 and the baking screen 102. For instance, the food item 104 and the baking screen 102 may tend to stick to each other in a pattern, but the air flow holes may break the locus of stickiness at several different points.

The size, shape, the number, and/or the arrangement of the air flow holes may be configured based on the type of the food item 104. Larger air flow holes may generate more upward pressure, but the cheese and toppings on the food item may be prone to get caught in the larger air flow holes. In these cases, smaller air flow holes may be desired. In a food item 104 with relatively large pieces of toppings and or cheese larger air flow holes may be desired. The shapes of the air flow holes may generally be circular, but other shapes may be used based on the characteristics of the food item. The air flow holes may generally be arranged in concentric circles (e.g., with an air flow hole at the center), but other arrangements may be used based on the characteristics of the food item 104. For instance, if there is desire for the edges of the food item 104 to be crispier than the central parts, the central parts of the baking screen 102 may have a higher concentration of the air flow holes and the edge portions may have a lower concentration of the air flow holes. The total number of air flow holes in the baking screen 102 may also be configured based on the characteristics of the food item 104.

The geometrical attributes of the baking screen 102 itself may be configured based on the characteristics of the food item 104. In the instances of the food item 104 being a thin crusted pizza for example, a relatively thin baking screen 102 may be used. As another example, when the food item 104 is a flatbread sandwich (e.g., Papa John's Papadia® product), the diameter of the baking screen 102 may be, e.g., 9 inches. In case of the food item 104 being a pizza, the diameter of the baking screen 102 may be, e.g., 14 inches. Although the shape of the baking screen 102 is generally shown to be circular, the baking screen 102 can be of any shape depending upon the shape of the food item 104. These are just but a few non-limiting examples of the geometric configurations of the baking screen 102 based on the characteristics of the food item, and other geometric configurations should also be considered within the scope of this disclosure.

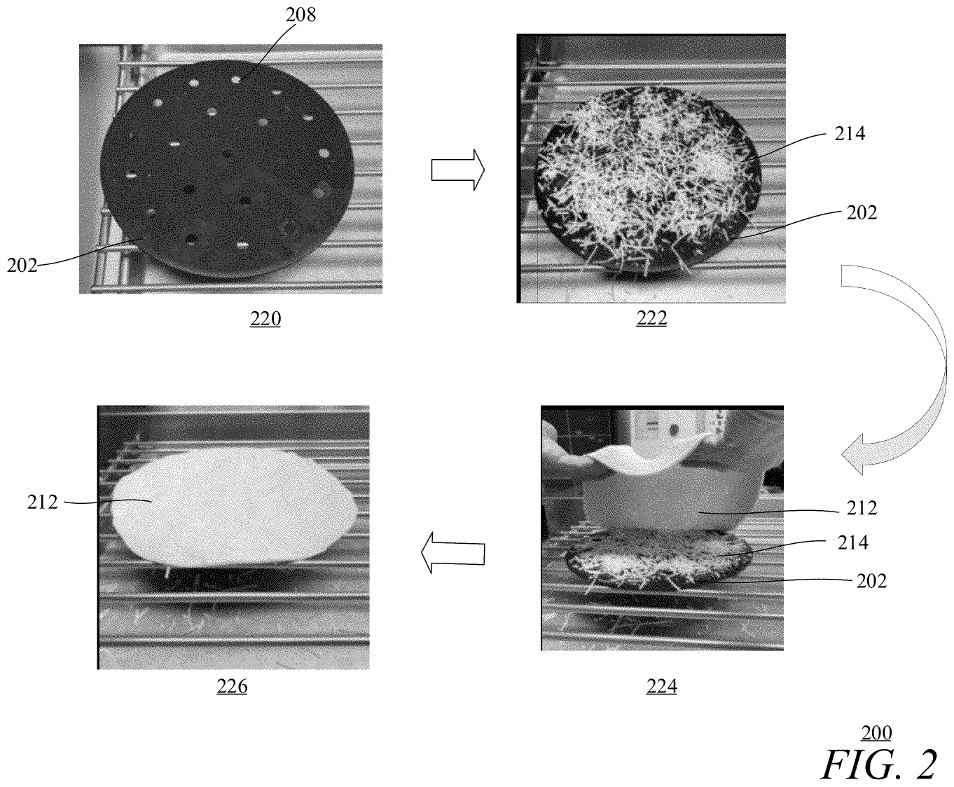

FIG. 2 shows an illustrative process 200 of preparing a food item for baking, based on the principles disclosed herein. It should however be understood that the steps shown in FIG. 2 are just examples and processes with additional, alternative, and fewer number of steps are within the scope of this disclosure. Furthermore, the circular baking screen and the circular food item are also just examples and therefore should not be considered limiting.

At step 220, a baking screen 202 (e.g., similar to baking screen 102 as shown in FIG. 1) may be laid down on a flat surface such as a kitchen counter. The baking screen 202 may have multiple air flow holes (an example air flow hole is labeled as 208). The baking screen 202, when laid flat as shown, may be ready for receiving ingredients of a food item to be baked, as shown in the subsequent steps. For instance, at step 222, a layer of cheese 214 and or toppings (not shown) may be spread on the baking screen 202. That is, the layer of cheese 214 and or the toppings may be in direct contact with the baking screen 202 during the baking process. At step 224, a layer of flattened dough 212 may be put on top of the layer of cheese 214 and or the toppings. As shown in step 226, the flattened dough 212 and the baking screen 202 (obscured by the flattened dough 212) may sandwich the layer of cheese 214 and or the toppings.

The side of the flattened dough 212 not facing the baking screen 202 (i.e., the visible side of the flattened dough 212 in FIG. 2) may receive additional cheese and/or other toppings. The food item produced using the principles disclosed herein may therefore include cheese and or toppings on both sides. After step 226, the combination of the flattened dough 212 and the cheese (e.g., layer of cheese 214), and or toppings may be placed in an oven (e.g., oven 106 shown in FIG. 1). Because of the air flow holes and the non-stickiness of the baking screen 202, the baked food item based on the flattened dough may not stick to (or may have minimal sticking to) the baking screen 202 and will not stick to the oven 106. As discussed above, this is a desired attribute for preparing food items having cheese and or toppings on both top and bottom sides.

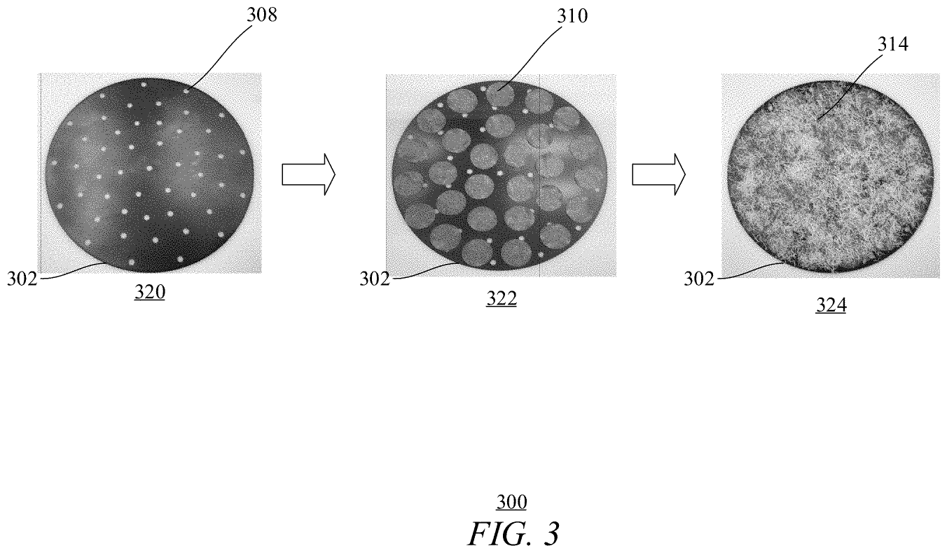

FIG. 3 shows another illustrative process 300 of preparing a food item for baking, based on the principles disclosed herein. It should be understood that the steps shown in FIG. 3 and described herein are merely exemplary and processes with alternative, additional, or fewer number of steps should be considered to be within the scope of this disclosure. Furthermore, the circular baking screen and the circular food item are also just examples and therefore should not be considered limiting.

At step 320, a baking screen 302 may be laid on a flat surface, such as a kitchen table. Being on the flat surface may allow the baking screen 302 to receive the ingredients of a food item to be baked (e.g., a thin crusted pepperoni pizza). For example, at step 322, the baking screen may receive a topping 310 (e.g., pepperoni). At 324, the cheese covered the baking screen may receive a layer of cheese 314.

After the preparation shown in steps 320-324, a flatbread dough (also known in the art as a skin) may be spread covering the topping 310 and the layer of cheese 314. On the flatbread dough, another layer of cheese and or another set of toppings may be added. This combination, i.e., containing the toppings and or cheese on both sides of a flat dough on the baking screen 302 may be placed in an oven (e.g., oven 106 as shown in FIG. 1). The baking screen 302 may contact heat the topping 310 and the cheese 314. Furthermore, air flow holes (e.g., air flow hole 308) may allow the circulation of air between the food item and the oven. The air circulation combined with a reduction in contact surface area may mitigate any potential problem of the food item sticking to the baking screen 302.

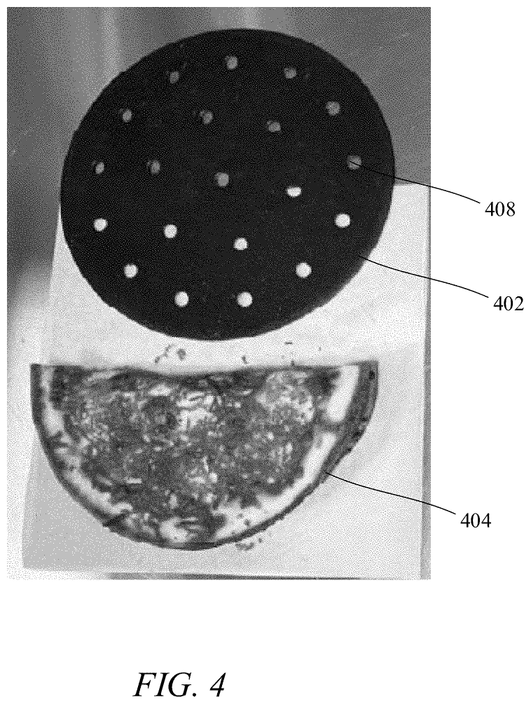

FIG. 4 shows an illustrative folded baked food item 404, based on the principles disclosed herein. The food item 404 may have been baked using one or more of the processes 200 or 300 discussed above. The baking may have been performed in an oven (e.g., oven 106 shown in FIG. 1) where the food item 404 may have been placed on a baking screen 402 (which may be similar to baking screen 202 and/or baking screen 302) with air flow holes (an example air flow hole has been labeled as 408).

The baked food item 404 may be a flatbread sandwich (e.g., Papa John's Papadia®). In other words, the baked food item 404 may be formed by folding a flat baked dough with toppings and or cheese on both the top and bottom surfaces. The toppings and or cheese on the top surface (e.g., not in contact with the baking screen 402) may be within the fold forming the internal surface of the flatbread sandwich, while the toppings and/or cheese on the bottom surface (e.g., in contact with the baking screen 402) may form the external surface of the flatbread sandwich.

However, it should be understood that the folded food item 404 is just an example of a dough product that may be baked on the baking screen 402. As another example, a food item on the baking screen 402 may not be folded—and may remain as, e.g., a flatbread pizza or bread with cheese and/or toppings on both sides.

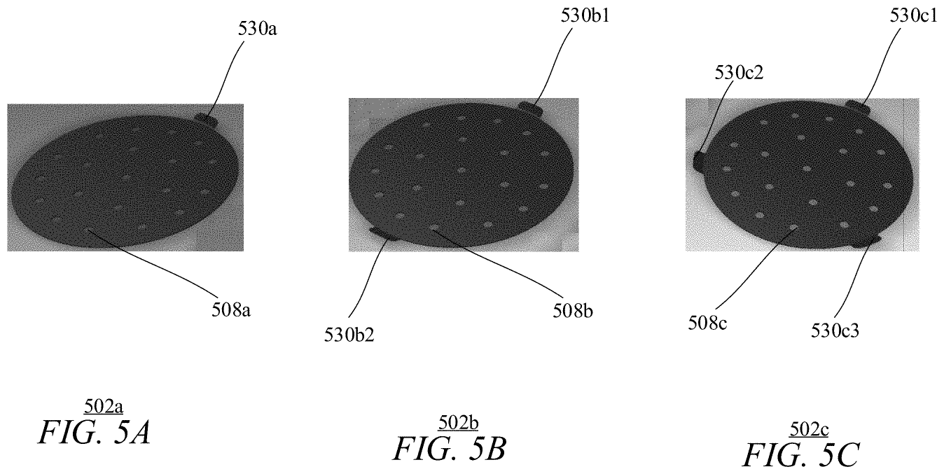

FIGS. 5A-5C show illustrative baking screens with tabs, based on the principles disclosed herein. In particular, the baking screens shown in FIGS. 5A-5C show baking screens with tabs that may be used to grab and move the screens (e.g., by hand or using a hook tool) and or to identify a corresponding food item in the oven. For example, FIG. 5A shows a baking screen 502a with a tab 530a. For the cases where the tab 530a may be used for identifying the food item, the identification information may be provided (e.g., printed) on the tab 530a. The baking screen 502a may also include air flow holes, an example of which has been labeled as 508a. As another example, FIG. 5B shows a baking screen 502b with two tabs 530b1 and 530b2. The two tabs 530b1 and 530b2 may have the same or different shapes and or sizes. For the cases where the tabs 530b1 and 530b2 may be used to identify food items on the baking screen 502b, the tabs 530b1 and 530b2 may have the same, similar or different identification information. Using the different identification information, the baking screen 502b may be used to identify different baked food items based on the orientation of the baking screen in the oven (e.g., based on which of the tabs 530b1 and 530b2 is visible from the outside). The baking screen 502b may also include air flow holes, an example of which has been labeled as 508b. As yet another example, FIG. 5C shows a baking screen 502c with three tabs 530c1, 530c2, and 530c3. The tabs 530c1, 530c2, and 530c3 may have the same or different shapes and or sizes. For the cases where the tabs 530c1, 530c2, and 530c3 contain identification information, the identification information may be the same, similar, or different. If different, the baked food item may be identified based on the orientation of the baking screen 502c (i.e., which of the tabs 530c1, 530c2, and 530c3 is visible from the outside). The baking screen 502c may also include air flow holes, an example of which is labeled as 508c.

Each of the baking screens 502a, 502b, and 502c may therefore provide the convenience identifying food items being baked thereon. For instance, a tab may be “Veggie Pizza,” another one may be “Pepperoni Pizza,” while a third one may be “Flatbread Sandwich.” This advantage may be combined with the convenience of moving the baking screens 502a, 502b, and 502c using the corresponding tabs. For example, personnel may grab by hand or a hook (and or any other type of engaging mechanism) at the end of a handle may be used to engage with tab, and using this engagement, the baking screen may be pushed into the oven, pulled out from the oven, or moved around within the oven.

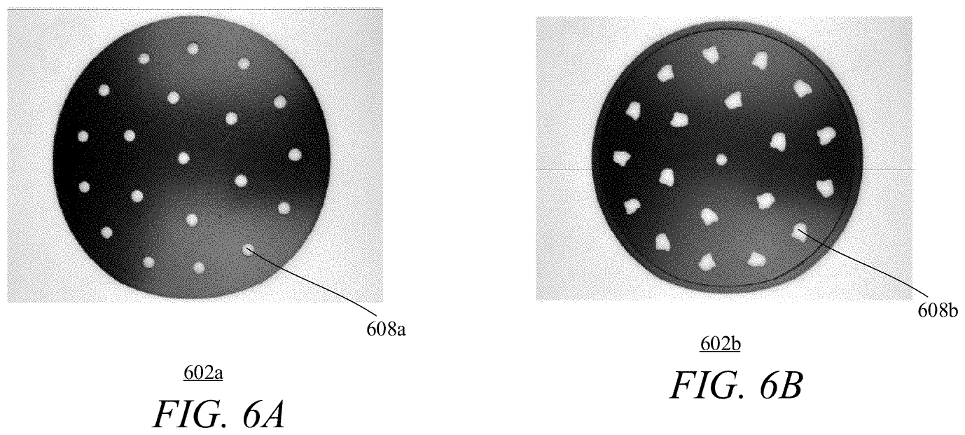

FIGS. 6A-6B show some examples of illustrative baking screens, based on the principles disclosed herein. Particularly, FIGS. 6A-6B show baking screen with different air flow hole shapes and/or sizes. For example, baking screen 602a of FIG. 6A includes air flow holes (an example has been labeled as 608a) that are circular; and baking screen 602b of FIG. 6B includes air flow holes (an example has been labeled as 608b) that are irregularly shaped. Furthermore, air flow holes of the baking screen 608a may be smaller than the air flow holes of the baking screen 608b. As described above, the sizing and/or shaping of the air flow holes may be based on the characteristics of the food item being baked thereon. For example, a food item requiring more crispiness may have smaller air flow holes.

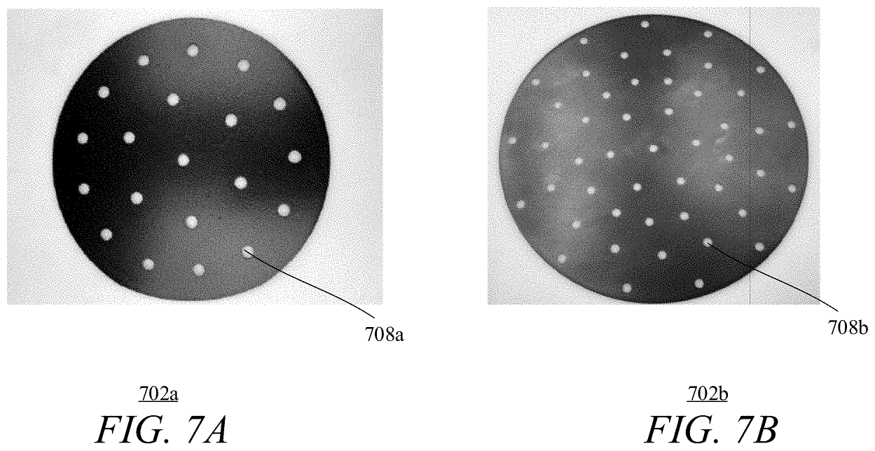

FIGS. 7A-7B show other examples of illustrative baking screens, based on the principles disclosed herein. Particularly, FIGS. 7A-7B illustrate that baking screens may have different number and distribution of the air flow holes. For example, FIG. 7A shows a baking screen 702a with a smaller number of (as shown, 20 air flow holes) and generally uniformly distributed air flow holes (an air flow hole has been labeled as 708a). As another example, FIG. 7B shows a baking screen 702b with a larger number of (as shown, 48 air flow holes) and non-uniformly distributed air flow holes (an air flow hole has been labeled as 708b). The number and/or distribution of the air flow holes may be based on the size of the baking screen and the characteristics of the food item being baked therein. For example, a larger baking screen may have a larger number of air flow holes. Baking screens for less crispy food items may have a large number of air flow holes to decrease the heating the contact surface between the baking screen and the food item. On the other hand, baking screen for crispier food items may have a smaller number of holes for a larger contact surface between the baking screen and the food item. The uniformity/non-uniformity of distribution of the air flow holes may also be dictated by the food item. For instance, if the food item may have to be crispy towards the edge and less crispy towards the center, there may be more air flow holes towards the center and less air flow holes towards the edge (e.g., distribution of the air flow holes shown in FIG. 7B).

Therefore, it should generally be understood that the baking screen described throughout this disclosure provide a wide range of configurability (e.g., during the manufacture) based on the characteristics of the food item to be prepared. Any parameter may be configured based on the characteristics of the food item. The thickness may be varied based on the cooking heat desired by the food item. The coating may be selected based on the desired non-stickiness. The shapes and sizes of the air flow holes may be configured based on the type of food being baked thereon. The total number of air flow holes and the distribution thereof may be configured based the crispiness and/or distribution of the crispiness of the food item. It should however be understood that these are just some example parameters; and configuration of other parameters should also be considered within the scope of this disclosure.

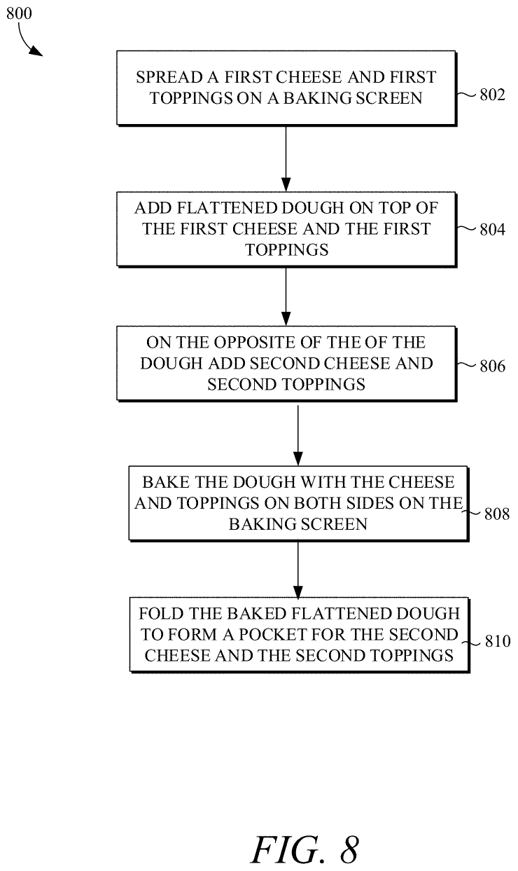

FIG. 8 shows a flow diagram of an illustrative method 800 of making a baked food item, based on the principles disclosed herein. It should be understood that the steps shown in FIG. 8 and described herein are merely examples and methods with additional, alternative, or fewer number of steps should also be considered within the scope of this disclosure.

The method of making the baked food item may begin at step 802, where a first cheese and or first toppings may be spread on a baking screen (several examples of baking screens are described above). The first cheese and or first toppings may form the bottom portion of the baked food item. Furthermore, the first cheese and or first toppings may directly be contact with the baking screen during the baking step (e.g., step 808).

At step 804, a flattened dough may be added on top of the first cheese and or first toppings. The flattened dough may cover the entirety of the first cheese and or first toppings. The flattened dough may be shaped to conform to the contours of baking sheet. For example, if the baking sheet is circular, the flattened dough may be circular as well (e.g., for a circular pizza or for a flatbread sandwich).

At step 806, second cheese and or second toppings may be added to the opposite side of the dough. The second cheese and or second toppings may form the top portion of the food item. Therefore, with the addition of the second cheese and or second toppings, the food item may have cheese and toppings on both sides.

At step 808, the dough with topping on both sides may be baked using the baking screen. The baking screen with all these ingredients may be put in an oven. The top portion of the dough containing the second cheese and or second toppings may be heated through convectional heating (e.g., heated air flow within the oven). The bottom portion of the dough containing the first cheese and or first toppings may be heated through contact heating (e.g., through the contact with the baking screen) and air flow.

At step 810, the baked flattened dough may be folded to form a pocket for the second cheese and the second toppings. In other words, the baked flattened dough may be taken off the baking screen (e.g., peeled off the baking screen) and the folded to form a flatbread sandwich (e.g., Papa John's Papadia® product). The second cheese and or second toppings may be within the internal pocket generated by the fold. The first cheese and the first toppings may form the external portion of the flatbread sandwich.

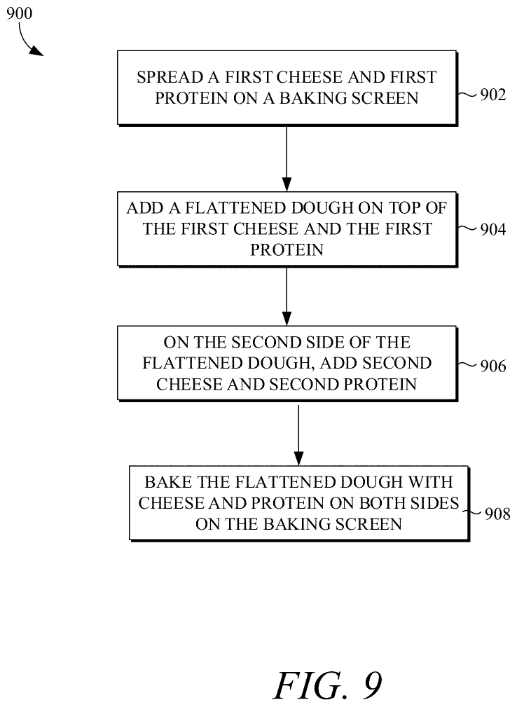

FIG. 9 shows a flow diagram of another illustrative method 900 of making a baked food item, based on the principles disclosed herein. It should be understood that the steps shown in FIG. 9 and described herein are merely examples and methods with additional, alternative, or fewer number of steps should also be considered within the scope of this disclosure.

The method 900 may begin at step 902, where a first cheese and first protein may be spread on a baking screen. The first cheese and the first protein may form the bottom toppings for the food item. For instance, the food item may be a pepperoni pizza and the first protein may be pepperoni.

At step 904, a flattened dough may be added on top of the first cheese and the first protein. In case of the food item being pizza, the flattened dough may be circular forming a circular pizza. The flattened dough may also form the crust of the food item.

At step 906, second cheese and second protein may be added to the second side of the flattened dough. The second cheese and the second protein may form the top portion of the baked food item. Therefore, with the first cheese and the first protein and the second cheese and the second protein, the flattened dough may have toppings on both the top side and the bottom side.

At step 908, the flattened dough with cheese and proteins on both sides may be baked using the baking screen. When in an oven, the top side of the flattened dough (e.g., containing the second cheese and the second protein) may be heated through, e.g., convection heating through air flow and the bottom side of the flattened dough (e.g., containing the first cheese and the first protein) may be contact heated by the baking screen. Once heated in the oven, the food item with cheese and toppings on both sides may be ready for serving.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of making a baked food item, the method comprising:
spreading a first cheese and or one or more first toppings on a baking screen comprising a plurality of air flow holes;
adding a flattened dough on top of the first cheese and or one or more first toppings such that the first cheese and or one or more first toppings are in between the baking screen and the flattened dough;
adding, on the opposite side of the flattened dough facing away from the baking screen, a second cheese and or one or more second toppings; and
baking, using the baking screen, the flattened dough with the first and second cheese and or first and second one or more toppings.

2. The method of claim 1, wherein the baked food item comprises a flatbread sandwich, the method further comprising:
after the baking, folding the baked flattened dough to make the flatbread sandwich such that the opposite side of the flattened dough forms a pocket for the second cheese and the one or more second toppings.

3. The method of claim 1, wherein the baking screen comprises a Polytetrafluoroethylene (PTFE) coated screen.

4. The method of claim 1, wherein the baking screen comprises a glazed screen.

5. The method of claim 1, wherein the baking screen comprises a circular screen.

6. The method of claim 5, wherein the plurality of air holes are arranged in concentric circles within the circular screen.

7. The method of claim 1, wherein the plurality of air holes are circular shaped.

8. The method of claim 1, wherein the plurality of air holes are irregularly shaped.

9. The method of claim 1, wherein the baking screen comprises one or more tabs adapted to be used for moving the baking screen and or comprising identifying information of the food item.

10. A method of making a flattened dough product with protein and cheese and both sides, the method comprising:
spreading a first cheese and a first protein on a baking screen with a plurality of air flow holes;
adding a flattened dough on top of the first cheese and the first protein such that the first cheese and the first protein are attached to the first side of the flattened dough facing the baking screen;
adding, on the second side of the flattened dough facing away from the baking screen, a second cheese and a second protein; and
baking, using the baking screen, the flattened dough with the first and second cheese and the first and second proteins to generate the flattened dough product.

11. The method of claim 10, wherein the flattened dough product comprises a flatbread food item with toppings on both sides.

12. The method of claim 10, wherein the baking screen comprises a Teflon coated screen.

13. The method of claim 10, wherein the plurality of air flow holes are configured in a pattern corresponding to crispness of at least one of the first protein or the second protein.

14. The method of claim 10, wherein the baking screen comprises a circular screen.

15. The method of claim 14, wherein the wherein the plurality of air holes are arranged in concentric circles within the circular screen.

16. The method of claim 10, wherein the plurality of air holes are circular shaped.

17. The method of claim 10, wherein the plurality of air holes are irregularly shaped.

18. A baking screen for a flattened dough product, the baking screen comprising:
a flat surface configured to:
receive a first layer of toppings and or cheese and a second layer of flattened dough and to provide contact heating to the toppings, cheese, and the flattened dough; and
a plurality of air holes through the flat surface and being configured to allow air flow between the toppings, cheese, and the flattened dough and the heating environment of an oven.

19. The baking screen of claim 18, comprising a circular screen, wherein the plurality of air holes are arranged on concentric circles within the circular screen.

20. The baking screen of claim 18, comprising at least one of a coated Polytetrafluoroethylene (PTFE) coated screen, a Teflon coated screen, or a glazed screen.
